(19) United States
(12) Patent Application Publication
(10) Pub. No.: US 2010/0170755 A1
(43) Pub. Date: Jul. 8, 2010

(54) MODULAR BRAKE CALIPER

(76) Inventor: Robert Biggs, Marietta, GA (US)

Correspondence Address: GEORGE R. REARDON, 3356 STATION COURT, LAWRENCVILLE, GA, 30044, US

(21) Appl. No.: 12/348,764

(22) Filed: Jan. 5, 2009

(51) Int. Cl. F16D 55/22

(52) U.S. Cl. 188/72.4

(57) ABSTRACT

In various exemplary embodiments, the technology described herein provides a modular hydraulic brake caliper for use on automobile vehicles and motorcycles. A modular hydraulic disc brake caliper housing to house a piston block assembly includes one or more top bridge configured to stiffen and strengthen a disc brake caliper. The housing includes one or more caliper body configured to stiffen and strengthen a modular hydraulic brake caliper assembly, to securely receive the top bridge and to restrain a piston block assembly, and is configured with or without the use of an integral piston. The housing can include at least one side bridge configured to stiffen and strengthen the modular hydraulic brake caliper assembly. The housing can include at least one end bridge configured to secure one side bridge to another and to the top bridge. A modular hydraulic disc brake caliper assembly, a disc brake assembly, and associated methods are disclosed.

### FIELD OF THE INVENTION

The technology described herein relates generally to disc brake systems for automobile vehicles and motorcycles. More specifically, this technology relates to a modular brake caliper.

### BACKGROUND OF THE INVENTION

In various applications, many automobile vehicles and motorcycles utilize disc brake systems. Disc brake systems have brake calipers. A brake caliper is an assembly which houses the brake pads and pistons. There is an ongoing challenge to maintain the integrity of brake calipers. By way of example, many brake calipers known in the art are mono-block assemblies, wherein the caliper body and piston bores are machined from one original piece. Maintaining strength, stiffness, and performance of such brake calipers with known methods often results in manufacturing complexity, increased cost, and complex geometry to achieve better stress optimization.

A related patent known is U.S. Pat. No. 5,810,121, issued to Anger et al. on Sep. 22, 1998. This patent discloses a modular pin mounted caliper assembly for use in a disc brake. The modular caliper assembly can be angled with one or more other modular caliper assemblies. Each caliper segment has a housing with a piston disposed in an inboard portion thereof for movement in an axial direction. A pair of flanges extends from opposite sides of the housing and is axially offset from each other enabling the connection and alignment of a plurality of segments. The resulting caliper can be used in a wide variety of vehicles despite changes in brake torque requirements. The modular caliper assembly includes a plurality of inboard and outboard brake shoe pairs. Each brake shoe has a pair of pin engaging features extending from opposite outboard ends of the brake shoe. Like the caliper segment flanges, the pin engaging features are axially offset from one another, enabling the shoes to be overlapped on common pins.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a modular hydraulic brake caliper for use on automobile vehicles and motorcycles.

In one exemplary embodiment, the technology described herein provides a modular hydraulic disc brake caliper assembly with integral piston block. The caliper assembly includes at least one top bridge configured to stiffen and strengthen the caliper assembly, to oppose hydraulic forces, to oppose braking forces, and to provide for movement of an air flow through the caliper assembly to cool the caliper assembly. The caliper assembly includes at least one side bridge with an integral piston block configured to interconnect with the top bridge, to house an at least one piston that applies force to a brake pad, to deliver pressurized hydraulic brake fluid to an at least one piston bore, to stiffen and strengthen the caliper assembly, to oppose hydraulic forces, and to oppose braking forces. The caliper assembly includes at least one end bridge configured to interconnect with the top bridge and side bridge, to stiffen and strengthen the caliper assembly, to oppose hydraulic forces, and to oppose braking forces.

The material of manufacture and the geometric shape, size, and configuration of each of the at least one top bridge, at least one side bridge with an integral piston block, and at least one end bridge comprising the caliper assembly is varied in manufacture in order to optimize weight, strength, and dimensional characteristics.

The caliper assembly can further include a heat shield disposed upon the integral piston block and configured to reduce radiant heat transfer into the piston block and side bridge. The caliper assembly can further include a coating applied to one or more of the at least one top bridge, at least one side bridge with an integral piston block, and at least one end bridge comprising the caliper assembly to prevent corrosion, reduce heat transfer, and increase lubricity. The caliper assembly can further include a means of attachment to interconnect the at least one top bridge, at least one side bridge with an integral piston block, and at least one end bridge comprising the caliper assembly.

In another exemplary embodiment, the technology described herein provides a modular hydraulic disc brake caliper assembly with integral piston block. This caliper assembly includes at least one top bridge configured to stiffen and strengthen the caliper assembly, to oppose hydraulic forces, to oppose braking forces, and to provide for movement of an air flow through the caliper assembly to cool the caliper assembly. This caliper assembly includes at least one side bridge with an integral piston block configured to interconnect with the top bridge, to house an at least one piston that applies force to a brake pad, to deliver pressurized hydraulic brake fluid to an at least one piston bore, to stiffen and strengthen the caliper assembly, to oppose hydraulic forces, and to oppose braking forces. This caliper assembly includes at least one caliper body configured to interconnect with the top bridge and the side bridge, to stiffen and strengthen the caliper assembly, to oppose hydraulic forces, and to oppose braking forces.

The material of manufacture and the geometric shape, size, and configuration of each of the at least one top bridge, at least one side bridge with an integral piston block, and at least one caliper body comprising the caliper assembly is varied in manufacture in order to optimize weight, strength, and dimensional characteristics.

This caliper assembly can include a heat shield disposed upon the integral piston block and configured to reduce radiant heat transfer into the integral piston block and caliper body. This caliper assembly can include a coating applied to one or more of the at least one top bridge, at least one side bridge with an integral piston block, and at least one caliper body comprising the caliper assembly to prevent corrosion, reduce heat transfer, and increase lubricity. This caliper assembly includes a means of attachment to interconnect the at least one top bridge, at least one side bridge with an integral piston block, and at least one caliper body comprising the caliper assembly.

In yet another exemplary embodiment, the technology described herein provides a modular hydraulic disc brake caliper assembly with integral piston block. This caliper assembly includes at least one top bridge, configured to stiffen and strengthen the caliper assembly, to oppose hydraulic forces, to oppose braking forces, and to provide for movement of an air flow through the caliper assembly to cool the caliper assembly. This caliper assembly includes at least one side bridge with an integral piston block configured to interconnect with the top bridge, to house an at least one piston that applies force to a brake pad, to deliver pressurized hydraulic brake fluid to an at least one piston bore, to stiffen and strengthen the caliper assembly, to oppose hydraulic forces, and to oppose braking forces.

The material of manufacture and the geometric shape, size, and configuration of each of the at least one top bridge and at least one side bridge with an integral piston block comprising the caliper assembly is varied in manufacture in order to optimize weight, strength, and dimensional characteristics.

This caliper assembly can include a heat shield disposed upon the integral piston block and configured to reduce radiant heat transfer into the integral piston block. This caliper assembly can include a coating applied to one or more of the at least one top bridge and at least one side bridge with an integral piston block comprising the caliper assembly to prevent corrosion, reduce heat transfer, and increase lubricity. This caliper assembly includes a means of attachment to interconnect the at least one top bridge and at least one side bridge with an integral piston block comprising the caliper assembly.

In yet another exemplary embodiment, the technology described herein provides a modular hydraulic disc brake caliper assembly with integral piston block. This caliper assembly includes at least one top bridge configured to stiffen and strengthen the caliper assembly, to oppose hydraulic forces, to oppose braking forces, and to provide for movement of an air flow through the caliper assembly to cool the caliper assembly. This caliper assembly includes at least one caliper body with an integral piston block configured to interconnect with the top bridge, to house an at least one piston that applies force to a brake pad, to deliver pressurized hydraulic brake fluid to an at least one piston bore, to stiffen and strengthen the caliper assembly, to oppose hydraulic forces, and to oppose braking forces.

The material of manufacture and the geometric shape, size, and configuration of each of the at least one top bridge and at least one caliper body with an integral piston block comprising the caliper assembly is varied in manufacture in order to optimize weight, strength, and dimensional characteristics.

This caliper assembly can include a heat shield disposed upon the integral piston block and configured to reduce radiant heat transfer into the integral piston block and caliper body. This caliper assembly can include a coating applied to one or more of the at least one top bridge and at least one caliper body with an integral piston block comprising the caliper assembly to prevent corrosion, reduce heat transfer, and increase lubricity. This caliper assembly includes a means of attachment to interconnect the at least one top bridge and at least one caliper body with an integral piston block comprising the caliper assembly.

In yet another exemplary embodiment, the technology described herein provides a modular hydraulic disc brake caliper assembly configured without the use of an integral piston block. The caliper assembly includes at least one top bridge configured to stiffen and strengthen the caliper assembly, to oppose hydraulic forces, to oppose braking forces, and to provide for movement of an air flow through the caliper assembly to cool the caliper assembly. The caliper assembly includes at least one side bridge configured to interconnect with the top bridge, to stiffen and strengthen the caliper assembly, to oppose hydraulic forces, and to oppose braking forces. The caliper assembly includes at least one end bridge configured to interconnect with the top bridge and side bridge, to stiffen and strengthen the caliper assembly, to oppose hydraulic forces, and to oppose braking forces. The caliper assembly includes at least one piston block configured to house an at least one piston that applies force to a brake pad, to deliver pressurized hydraulic brake fluid to an at least one piston bore.

The material of manufacture and the geometric shape, size, and configuration of each of the at least one top bridge, at least one side bridge, at least one end bridge, and at least one piston block comprising the caliper assembly is varied in manufacture in order to optimize weight, strength, and dimensional characteristics.

The caliper assembly can include a heat shield disposed upon the piston block and configured to reduce radiant heat transfer into the piston block and side bridge. The caliper assembly can include a coating applied to one or more of the at least one top bridge, at least one side bridge, at least one end bridge, and at least one piston block comprising the caliper assembly to prevent corrosion, reduce heat transfer, and increase lubricity. The caliper assembly includes a means of attachment to interconnect the at least one top bridge, at least one side bridge, at least one end bridge, and at least one piston block comprising the caliper assembly.

In still yet another exemplary embodiment, the technology described herein provides a modular hydraulic disc brake caliper assembly configured without the use of an integral piston block. This caliper assembly includes at least one top bridge configured to stiffen and strengthen the caliper assembly, to oppose hydraulic forces, to oppose braking forces, and to provide for movement of an air flow through the caliper assembly to cool the caliper assembly. This caliper assembly includes at least one side bridge configured to interconnect with the top bridge, to stiffen and strengthen the caliper assembly, to oppose hydraulic forces, and to oppose braking forces. This caliper assembly includes at least one caliper body configured to interconnect with the top bridge and the side bridge, to stiffen and strengthen the caliper assembly, to oppose hydraulic forces, and to oppose braking forces. This caliper assembly includes at least one piston block configured to house an at least one piston that applies force to a brake pad, to deliver pressurized hydraulic brake fluid to an at least one piston bore.

The material of manufacture and the geometric shape, size, and configuration of each of the at least one top bridge, at least one side bridge, at least one caliper body, and at least one piston block comprising the caliper assembly is varied in manufacture in order to optimize weight, strength, and dimensional characteristics.

This caliper assembly can include a heat shield disposed upon the piston block and configured to reduce radiant heat transfer into the piston block, caliper body, and side bridge. This caliper assembly can include a coating applied to one or more of the at least one top bridge, at least one side bridge, at least one caliper body, and at least one piston block comprising the caliper assembly to prevent corrosion, reduce heat transfer, and increase lubricity. This caliper assembly includes a means of attachment to interconnect the at least one top bridge, at least one side bridge, at least one caliper body, and at least one piston block comprising the caliper assembly.

In still yet another exemplary embodiment, the technology described herein provides a modular hydraulic disc brake caliper assembly configured without the use of an integral piston block. This caliper assembly includes at least one top bridge configured to stiffen and strengthen the caliper assembly, to oppose hydraulic forces, to oppose braking forces, and to provide for movement of an air flow through the caliper assembly to cool the caliper assembly. This caliper assembly includes at least one caliper body configured to interconnect with the top bridge, to stiffen and strengthen the caliper assembly, to oppose hydraulic forces, and to oppose braking forces. This caliper assembly includes at least one piston block configured to house an at least one piston that applies force to a brake pad, to deliver pressurized hydraulic brake fluid to an at least one piston bore.

The material of manufacture and the geometric shape, size, and configuration of each of the at least one top bridge, at least one caliper body, and at least one piston block comprising the caliper assembly is varied in manufacture in order to optimize weight, strength, and dimensional characteristics.

This caliper assembly can include a heat shield disposed upon the piston block and configured to reduce radiant heat transfer into the piston block and caliper body. This caliper assembly can include a coating applied to one or more of the at least one top bridge, at least one caliper body, and at least one piston block comprising the caliper assembly to prevent corrosion, reduce heat transfer, and increase lubricity. This caliper assembly includes a means of attachment to interconnect the at least one top bridge, at least one caliper body, and at least one piston block comprising the caliper assembly.

In still yet another exemplary embodiment, the technology described herein provides a modular hydraulic disc brake caliper assembly configured without the use of an integral piston block. This caliper assembly includes at least one top bridge configured to stiffen and strengthen the caliper assembly, to oppose hydraulic forces, to oppose braking forces, and to provide for movement of an air flow through the caliper assembly to cool the caliper assembly. This caliper assembly includes at least one side bridge configured to interconnect with the top bridge, to stiffen and strengthen the caliper assembly, to oppose hydraulic forces, and to oppose braking forces. This caliper assembly includes at least one piston block configured to house an at least one piston that applies force to a brake pad, to deliver pressurized hydraulic brake fluid to an at least one piston bore.

The material of manufacture and the geometric shape, size, and configuration of each of the at least one top bridge, at least one side bridge, and at least one piston block comprising the caliper assembly is varied in manufacture in order to optimize weight, strength, and dimensional characteristics.

This caliper assembly can include a heat shield disposed upon the piston block and configured to reduce radiant heat transfer into the piston block and side bridge. This caliper assembly can include a coating applied to one or more of the at least one top bridge, at least one side bridge, and at least one piston block comprising the caliper assembly to prevent corrosion, reduce heat transfer, and increase lubricity. This caliper assembly includes a means of attachment to interconnect the at least one top bridge, at least one side bridge, and at least one piston block comprising the caliper assembly.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view of a modular hydraulic brake caliper having a split interlocking multi-piston block design with side and end bridges, according to an embodiment of the technology;

FIG. 2 is an expanded front perspective view of the modular hydraulic brake caliper having a split interlocking multi-piston block design with side and end bridges depicted in FIG. 2;

FIG. 3 is a front perspective view of a modular hydraulic brake caliper having an interlocking multi-piston design with integral piston blocks, according to an embodiment of the technology;

FIG. 4 is an expanded front perspective view of the modular hydraulic brake caliper having an interlocking multi-piston design with integral piston blocks depicted in FIG. 3;

FIG. 5 is a front perspective view of a modular hydraulic brake caliper having a multi-piston block with integral side bridge, according to an embodiment of the technology;

FIG. 6 is an expanded front perspective view of the modular hydraulic brake caliper having a multi-piston block with integral side bridge depicted in FIG. 5;

FIG. 7 is a front perspective view of a modular hydraulic brake caliper having a multi-piston block with side bridge, according to an embodiment of the technology;

FIG. 8 is an expanded front perspective view of the modular hydraulic brake caliper having a multi-piston block with side bridge depicted in FIG. 7;

FIG. 9 is a front perspective view of a modular hydraulic brake caliper having a multi-piston block with integral side bridge for a motorcycle, according to an embodiment of the technology,

FIG. 10 is an expanded front perspective view of the modular hydraulic brake caliper having a multi-piston block with integral side bridge for a motorcycle depicted in FIG. 9;

FIG. 11 is a front perspective view of a modular hydraulic brake caliper having a single piston block configuration, according to an embodiment of the technology;

FIG. 12 is an expanded front perspective view of the modular hydraulic brake caliper having a single piston block configuration depicted in FIG. 11;

FIG. 13 is a front perspective view of a modular hydraulic brake caliper having a twin piston block configuration, according to an embodiment of the technology;

FIG. 14 is an expanded front perspective view of the modular hydraulic brake caliper having a twin piston block configuration depicted in FIG. 13;

FIG. 15 is a front perspective view of a modular hydraulic brake caliper having an interlocking multi-piston block configuration with integral side bridge and end bridge, according to an embodiment of the technology;

FIG. 16 is an expanded front perspective view of the modular hydraulic brake caliper having an interlocking multi-piston block configuration with integral side bridge and end bridge depicted in FIG. 15;

FIG. 17 is a front perspective view of a modular hydraulic brake caliper having an interlocking multi-piston block configuration with integral side bridge, according to an embodiment of the technology;

FIG. 18 is an expanded front perspective view of the modular hydraulic brake caliper having an interlocking multi-piston block configuration with integral side bridge depicted in FIG. 17;

FIG. 19 is a front perspective view of a modular hydraulic brake caliper having an interlocking multi-piston block configuration with integral side bridge and end bridge, according to an embodiment of the technology; and

FIG. 20 is an expanded front perspective view of the modular hydraulic brake caliper having an interlocking multi-piston block configuration with integral side bridge and end bridge depicted in FIG. 19.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

Standard performance brake calipers are made in two halves and bolted together. To improve strength, stiffness, and performance, brake calipers are made as mono-block assemblies. For example, caliper body and piston bores are machined from one piece. This creates manufacturing complexity and high cost. Further improvement on the mono-block technology has led to very complex machined caliper bodies to maximize strength.

In various exemplary embodiments, the technology described herein provides a modular hydraulic brake caliper for use on automobile vehicles and motorcycles. The modular hydraulic brake caliper provides equivalent or greater stiffness and strength and is manufactured at a lower cost. Additionally, performance is increased in both weight and heat resistance through the use of advanced materials and coatings. Furthermore, the modular hydraulic brake caliper places reaction forces through the bolt attachments. The modular hydraulic brake caliper separates the major components into modules which allows for functional optimization through the use of materials, geometric stress optimization, and coatings.

A modular hydraulic disc brake caliper 10 having a housing to house a piston block assembly 26 is disclosed. The housing includes at least one top bridge 16. The top bridge 16 is configured to stiffen and strengthen a disc brake caliper. In at least one embodiment, the top bridge 16 is configured to be removable. The top bridge 16 is the primary component to provide added strength to a modular hydraulic disc brake caliper 10, when compared to the traditional two-piece and open-top, mono-block brake caliper designs known in the art. The top bridge 16 can be designed to strengthen and oppose piston hydraulic reaction forces as well as to stiffen the caliper opposing tangential braking forces. The modular top bridge 16 allows for material and geometric optimization for strength requirements based on specific applications. The modular top bridge 16 can be designed in many fashions, providing attachment on different planes, and using different attachment methods. By way of example, attachments means can include a mechanical fastener, press and shrink fit, glue, adhesive, and welding.

The housing of the modular hydraulic disc brake caliper 10 can also include one or more caliper body 36. The caliper body 36 is configured to stiffen and strengthen a modular hydraulic brake caliper assembly 10, to securely receive the top bridge 16 and to restrain a piston block assembly 26. The caliper body 36 can be configured with an integral piston or without the use of an integral piston. The caliper body 36 can include a single piece or two separate parts connected using side bridges 32. This non-integral caliper body design eliminates the use of integral pistons and, thus, simplifies the manufacturing process. The caliper body 36 can be optimized for tangential loading and less biased on piston hydraulic reaction forces. Alternatively, the caliper body 36 can be optimized for both factors.

The side bridges 32 used in two-piece caliper body 36 embodiments tie the two pieces of the caliper body 36 together. The side bridge 32 is bolted to each caliper body 36 to join them together. The side bridge 32 can be optimally designed to oppose piston hydraulic reaction forces as well as opposing tangential braking forces. The side bridge 32 can be designed in many fashions, providing attachment on different planes, and using different attachment methods. End bridges 20 can also be used in two-piece caliper body 36 embodiments to join two side bridges 32.

Components of each modular hydraulic disc brake caliper 10 can be altered to accommodate specific applications. Both racing and automobile applications are focused on the same disc brake caliper performance. For the auto applications, cost will be a greater driving force and yield compromises in balancing a lower required performance threshold, as compared to racing, with material and manufacturing costs.

The geometric shape of the components is very important to the functionality of this technology. The geometric shape, size, and configuration of each component are varied in manufacture in order to yield desired strength and dimensional characteristics. The shapes and sizes depicted in the Figures are exemplary. As will be apparent to those of ordinary skill in the art, varied shapes and sizes can be utilized for these components.

The material of manufacture of each of the components is varied in manufacture in order to optimize weight and strength characteristics. In regard to weight, lower is better in performance. Light and strong materials such as aluminum, titanium, and magnesium can be used. Heavier materials with ultra high strength characteristics may be lighter in application given certain optimized geometric and attachment designs. Strength and stiffness of the part and assembly are determined by the material used, the geometric shape of the component, and attachment methods. These three interrelated factors are dependent on one another and are evaluated holistically.

Material costs of components are balanced based on market application, performance requirements, and performance gains.

Manufacturing costs are considered when evaluating the manufacturing components of each modular hydraulic disc brake caliper 10. All elements of the design are critical in creating the best product at the lowest price. Fundamental to this technology is focusing on the simplest machining processes, lowest cost capital machinery, standard mass produced tooling, least skilled manpower, lowest cost consumables, etc. The modular design opens up the prospect of making individual components by other process such as forging, molding, casting, etc.

Heat resistance is considered when evaluating the manufacturing components of each modular hydraulic disc brake caliper 10. It is important to reduce heat around the piston block 26. It is desirable to keep the brake fluid as cool as possible and therefore provide heat shields and insulating properties at the interface between the pistons 26 and brake pads 30. The modular piston block 26 allows for use of different materials and coatings to aid in this pursuit which is not as feasible with “mono-block” designs.

Cooling characteristics are considered when evaluating the manufacturing components of each modular hydraulic disc brake caliper 10. One element of the geometric design that will be tailored to allow the greatest amount of air flow around the friction interface of the pad and rotor 40, rotor cooling vane exhaust, and piston block 26.

Serviceability is considered when evaluating the manufacturing components of each modular hydraulic disc brake caliper 10. The modular piston block 26 allows for easy exchange of new, rebuilt, and or different piston configurations with out having to purchase a complete new caliper assembly.

Components can be manufactured from varied materials based upon the application of the modular hydraulic disc brake caliper 10. The desire is to find the best material that yields the highest performance in terms of strength, weight, heat characteristics, and cost for a given application. Geometric design is extremely critical to determining these factors and Finite Element Analysis will be used extensively to iterate best solutions. In addition to industry standard aluminum other materials such as titanium, magnesium, high strength steels, stainless steels, ceramic composites, carbon fiber composites, etc. may be used for certain components.

Due to the modular nature of the technology described herein, individual components easily can be coated to enhance the performance. This is not as easily done with the current state of the art “mono-block” design calipers. For instance the face of the piston block could be coated with a ceramic coating or inlay to insulate the pistons and brake fluid from heat. Coatings in general can be used to improve the base material in areas of corrosion resistance, esthetics, friction wear, insulating properties, etc.

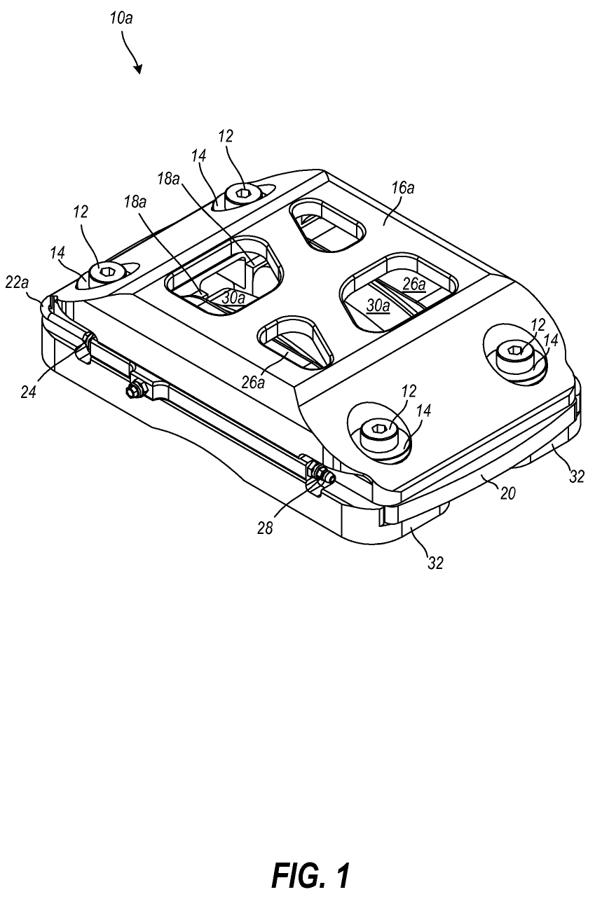

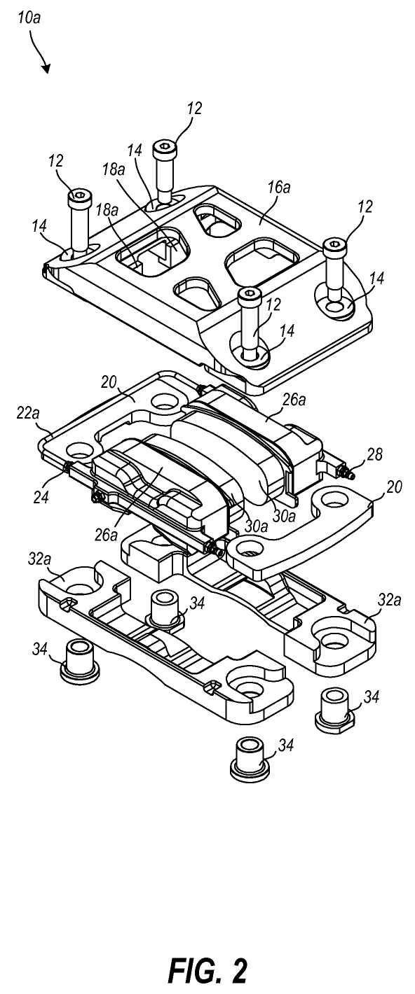

Referring now to FIGS. 1 and 2, a modular hydraulic brake caliper 10a having a split interlocking multi-piston block design with both side 32a and end bridges 20 is shown. The top bridge 16a is secured, for example, to the end bridges 20 and side bridges 32a with interlocking top bridge shoulder bolts 12. At each corner of the top bridge 16, a top bridge shoulder bolt 12 is placed through a split bushing 14 and through a hole in the end bridge 20 and through a hole in the side bridge 32 to a side bridge split bushing 34. The top bridge 16a utilizes abutment plates 18a to secure the brake pads 30a. Securely housed within the modular hydraulic brake caliper 10a are brake pads 30a, each disposed adjacent to a piston block 26a that selectively presses the brake pads 30a against a rotor. The pair of piston blocks 26a are fluidly connected via hydraulic crossover tube 22a, and each has at least one hydraulic tube fitting 24 and hydraulic bleed screw 28.

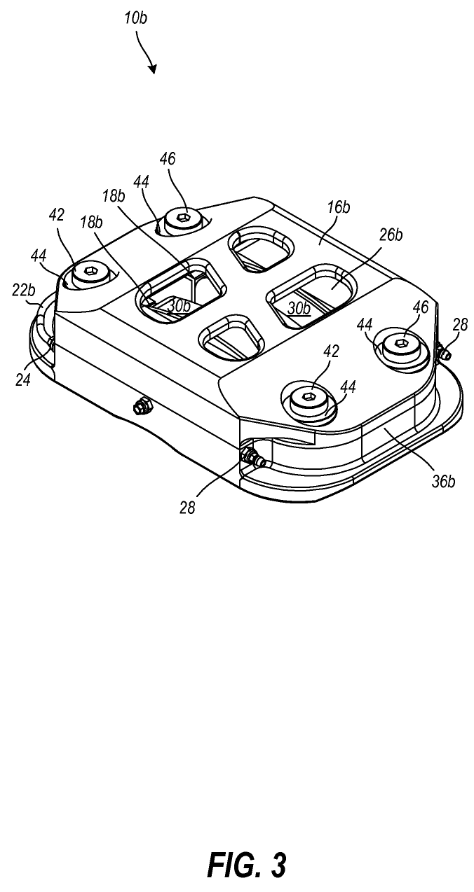

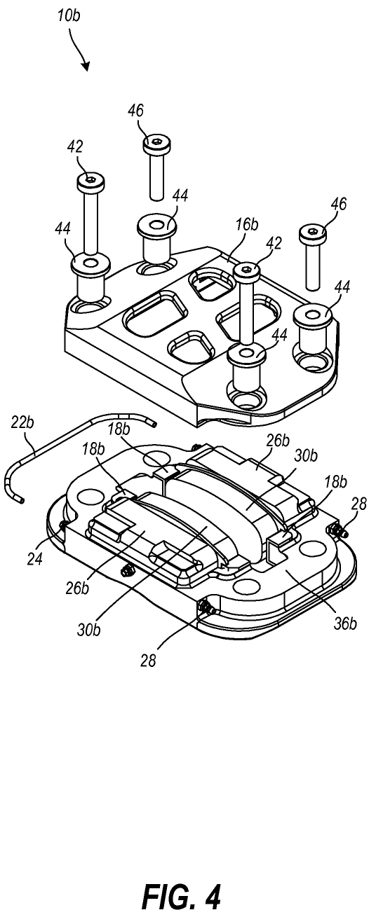

Referring now to FIGS. 3 and 4, a modular hydraulic brake caliper 10b having an interlocking multi-piston design with integral piston blocks 26b is shown. The top bridge 16b is secured, for example, to a caliper body 36b with top bridge mounting bolts 42 and top bridge interlocking bushings 44. The caliper body 36b utilizes abutment plates 18b to secure the brake pads 30b. Securely housed within the modular hydraulic brake caliper 10b are brake pads 30b, each disposed adjacent to an integral piston block 26b that selectively presses the brake pads 30b against a rotor. The integral piston block 26b is integrally formed with the caliper body 36b. On each side of the caliper body 36b the integral piston blocks 26b include at least one hydraulic tube fitting 24 and hydraulic bleed screw 28. Each side is fluidly connected via a hydraulic crossover tube 22b.

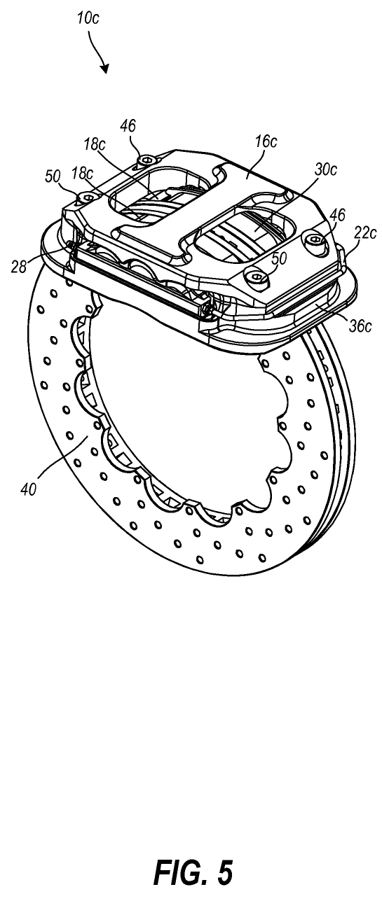

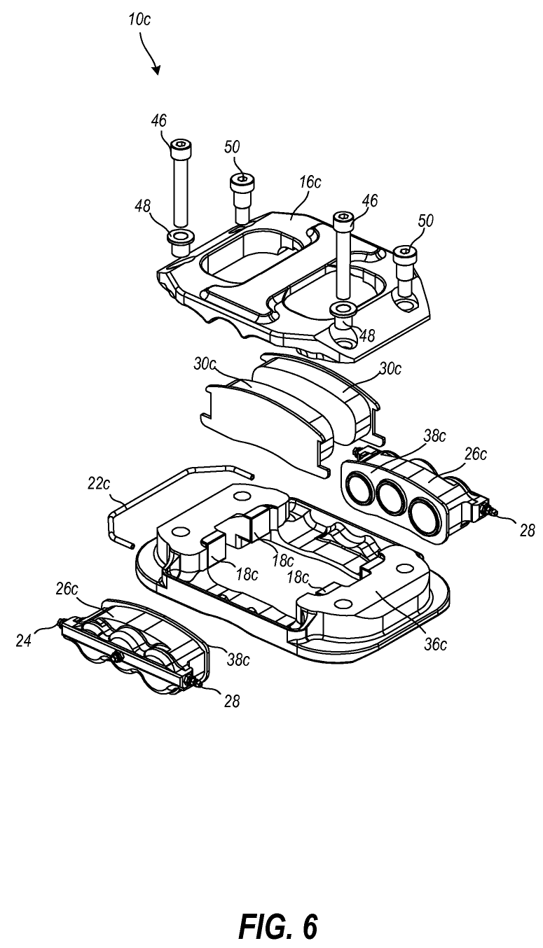

Referring now to FIGS. 5 and 6, a modular hydraulic brake caliper 10c having a multi-piston block with integral side bridge is shown on rotor 40. The top bridge 16c is secured, for example, to a caliper body 36c with top bridge bolts 46 and top bridge bushings 48 on one rotor side and top bridge shoulder bolts 50 on the opposite side. The caliper body 36c utilizes abutment plates 18c to secure the brake pads 30c. Securely housed within the modular hydraulic brake caliper 10c are brake pads 30c, each disposed adjacent to an integral piston block 26c that selectively presses the brake pads 30c against the rotor 40. Each piston block 26c is adjacent to each brake pad 30c and configured to selectively depress the brake pads 30c against the rotor 40. Each piston block 26c includes at least one hydraulic tube fitting 24 and hydraulic bleed screw 28. Each side is fluidly connected via a hydraulic crossover tube 22c.

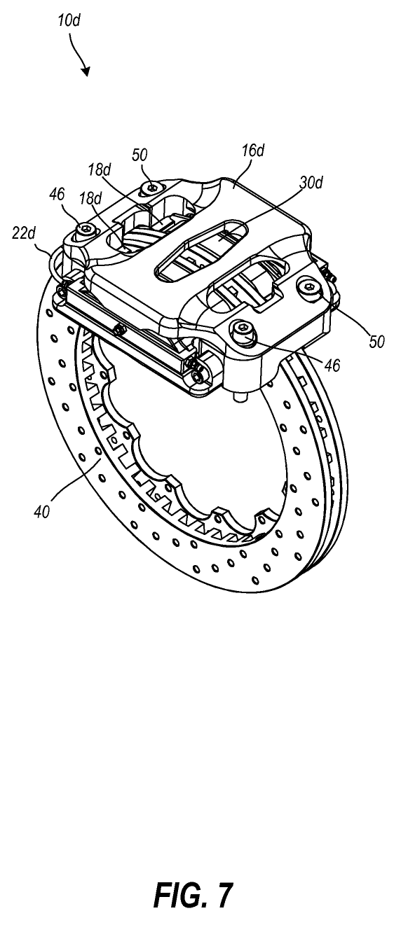

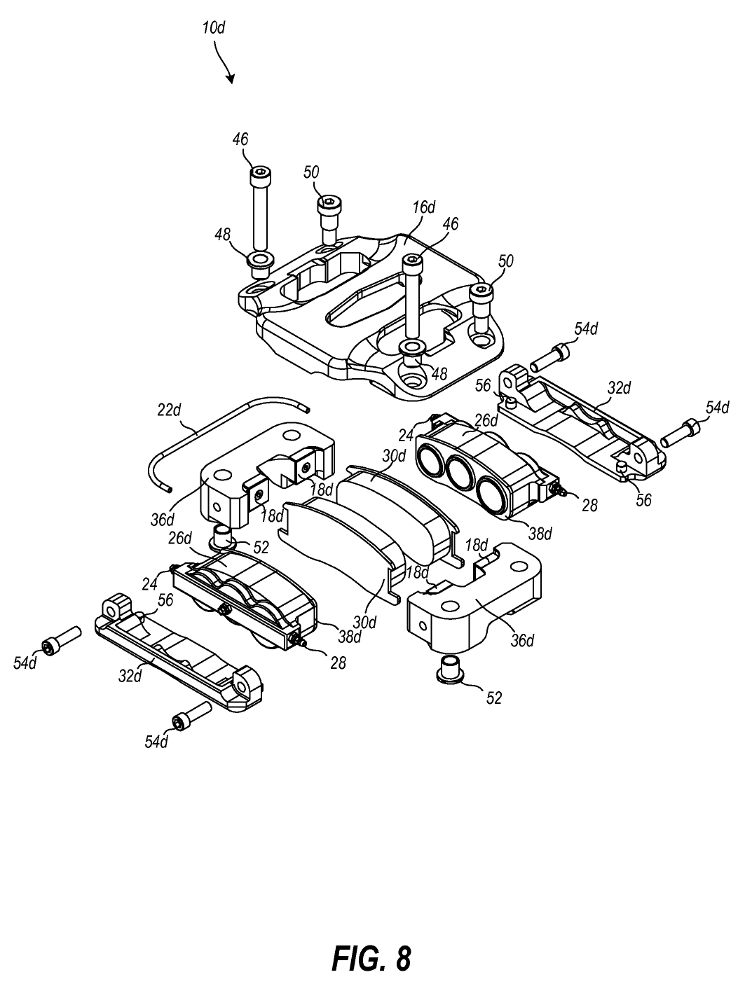

Referring now to FIGS. 7 and 8, a modular hydraulic brake caliper 10d having a multi-piston block 26d with side bridges 32d is shown on rotor 40. The top bridge 16d is secured, for example, to the caliper body 36d (in two pieces) with top bridge bolts 46 and top bridge bushings 48 on one rotor side and top bridge shoulder bolts 50 on the opposite side. Each is secured on the underside of the caliper body 36d with a caliper body bushing 52. The side bridges 32d are secured to the caliper body 36d with side bridge bolts 54 and side bridge pins 56. The caliper body 36d utilizes abutment plates 18d to secure the brake pads 30d. Securely housed within the modular hydraulic brake caliper 10d are brake pads 30d, each disposed adjacent to a piston block 26d that selectively presses the brake pads 30d against the rotor 40. Heat shields 38d are utilized to reduce radiant heat transfer into the piston block assembly 26d. The pair of piston blocks 26d are fluidly connected via hydraulic crossover tube 22d, and each has at least one hydraulic tube fitting 24 and hydraulic bleed screw 28.

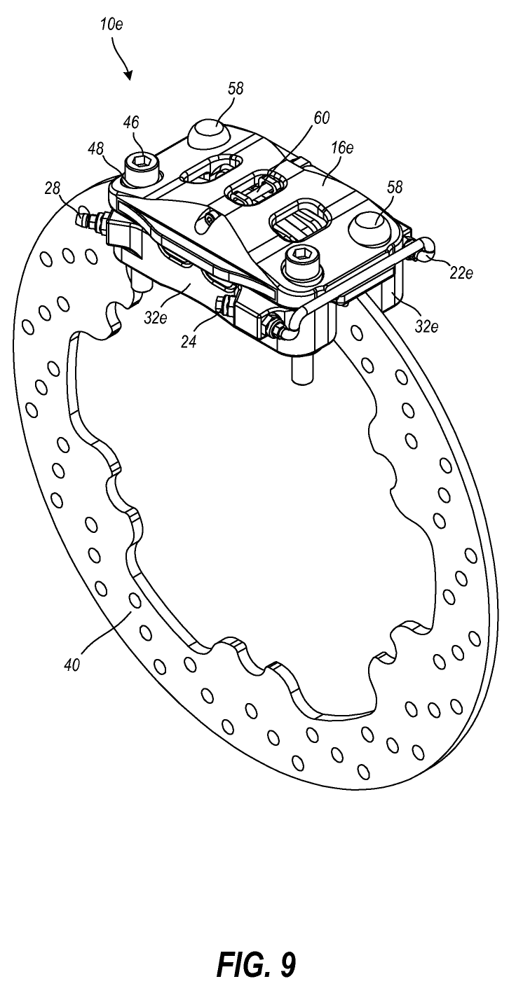

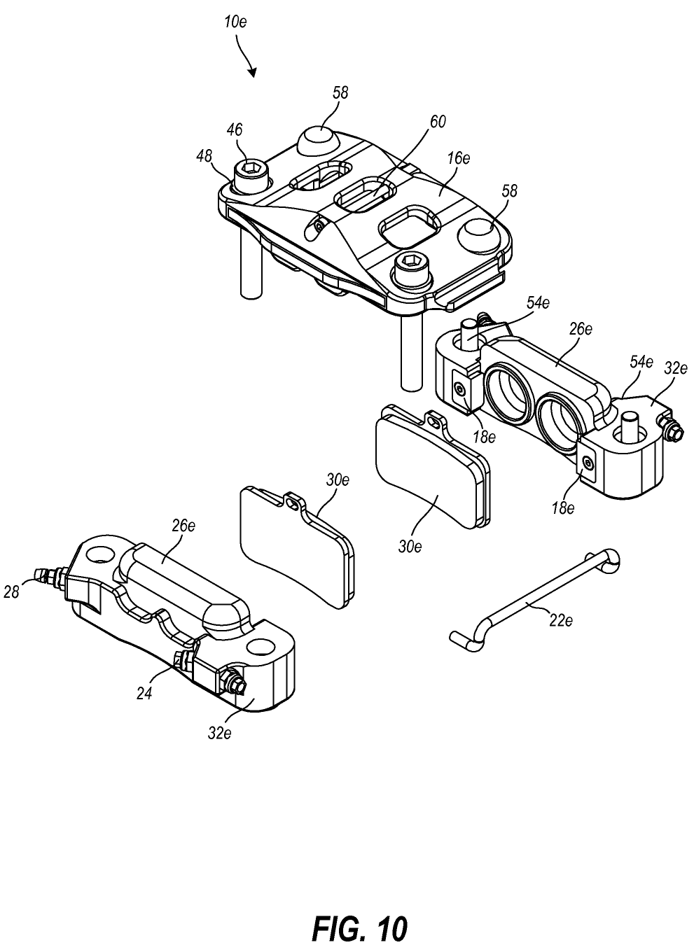

Referring now to FIGS. 9 and 10, a modular hydraulic brake caliper 10e having a multi-piston block 26e with integral side bridge 32e for a motorcycle is shown. The top bridge 16e is secured, for example, to the side bridges 32e with top bridge bolts 46 and top bridge bushings 48 on one rotor side and side bridge nuts 58 on the opposite side. In this embodiment, top bridge 16e utilizes a brake pad retainer 60. The side bridge nuts 58 connect with side bridge bolts 54 from the underside of one side bridge 32e. Securely housed within the modular hydraulic brake caliper 10e are brake pads 30e, each disposed adjacent to a piston block 26e that selectively presses the brake pads 30e against the rotor 40. The side bridges 32e utilize abutment plates 18e to secure the brake pads 30e. The pair of piston blocks 26e are fluidly connected via hydraulic crossover tube 22e, and each has at least one hydraulic tube fitting 24 and hydraulic bleed screw 28.

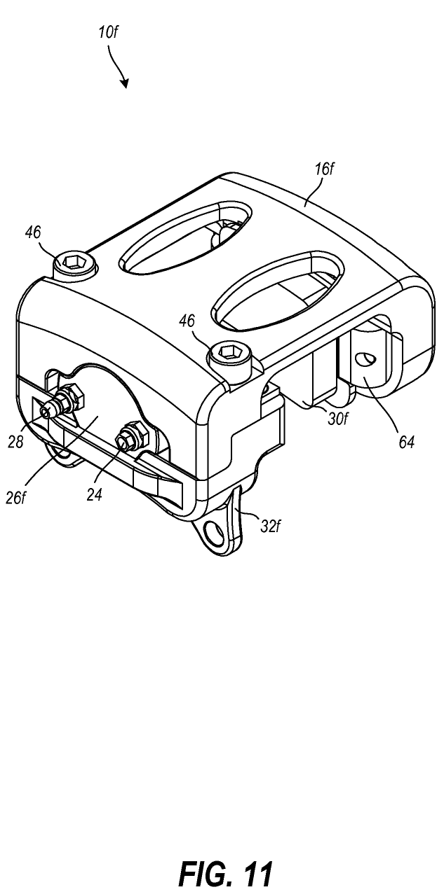

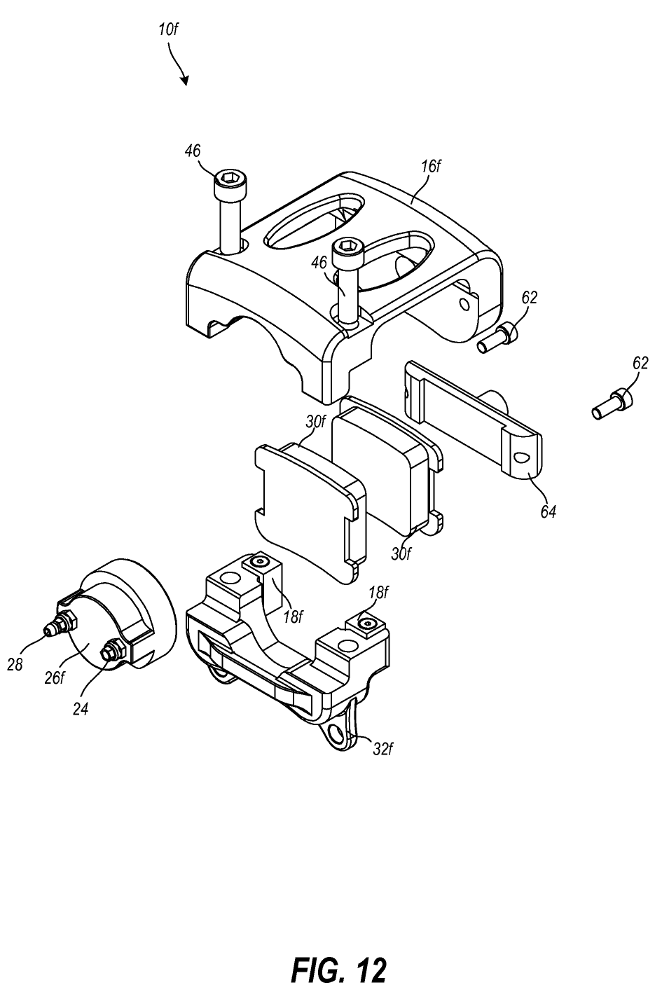

Referring now to FIGS. 11 and 12, a modular hydraulic brake caliper 10f having a single piston block 26f configuration is shown. The top bridge 16f is secured, for example, to the side bridge 32f with top bridge bolts 46. Securely housed within the modular hydraulic brake caliper 10f are brake pads 30f, one disposed adjacent to the single piston block 26f that selectively presses the brake pads 30f against the rotor and another disposed against a backing plate 64. The backing plate 64 is secured to the top bridge 16f, with the brake pads 30f disposed in between, with backing plate bolts 62. The side bridge 32f utilizes abutment plates 18f to secure the brake pads 30f. The piston block 26f has a hydraulic tube fitting 24 and a hydraulic bleed screw 28.

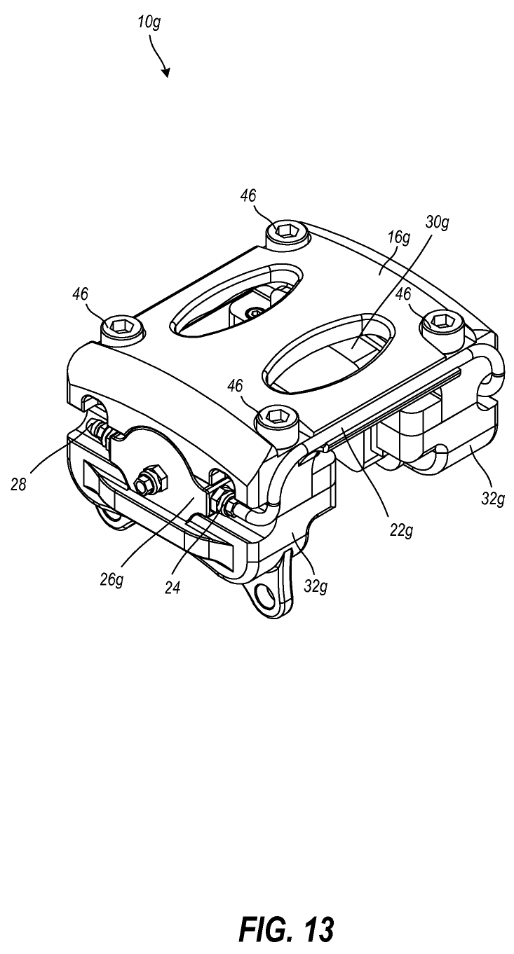

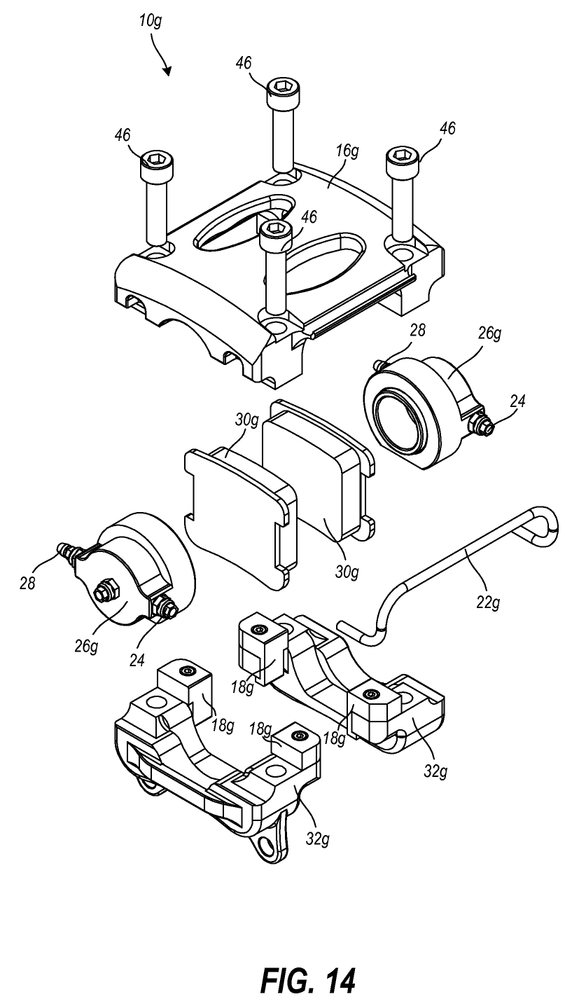

Referring now to FIGS. 13 and 14, a modular hydraulic brake caliper 10g having a twin piston block 26g configuration is shown. The top bridge 16g is secured, for example, to the side bridges 32g with top bridge bolts 46. Securely housed within the modular hydraulic brake caliper 10g are brake pads 30g, each disposed adjacent to a piston block 26g that selectively presses the brake pads 30g against the rotor. The side bridges 32g utilizes abutment plates 18g to secure the brake pads 30g. Each piston block 26g has a hydraulic tube fitting 24 and a hydraulic bleed screw 28 and are fluidly coupled one via a hydraulic crossover tube 22g.

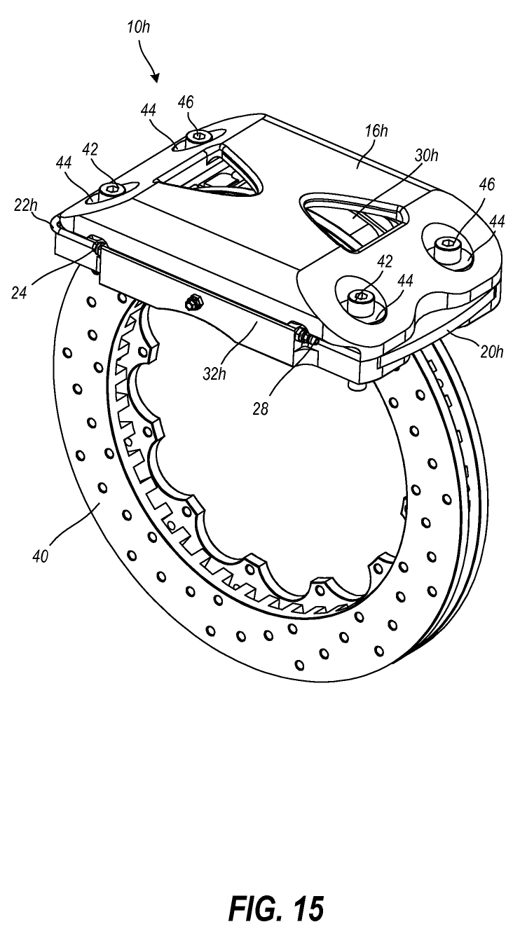

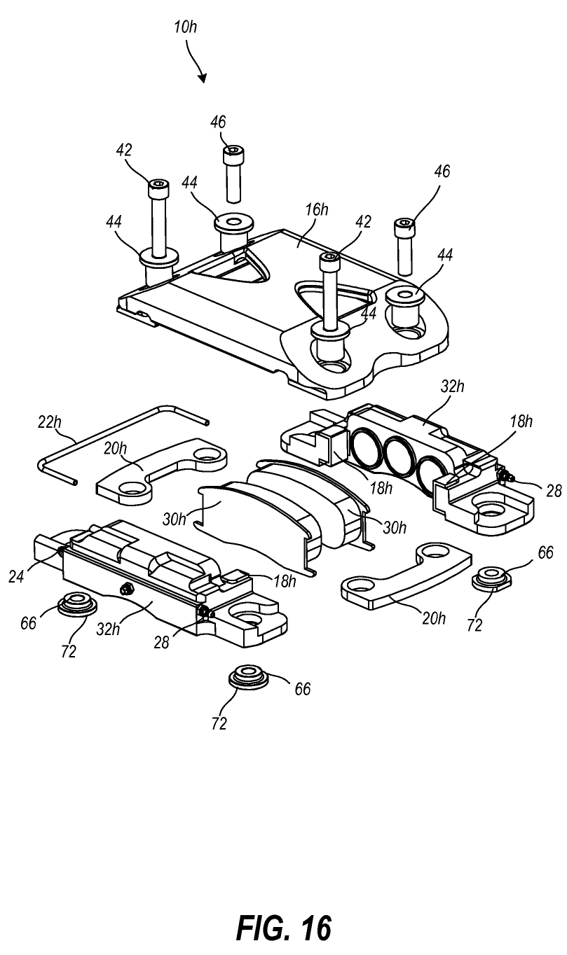

Referring now to FIGS. 15 and 16, a modular hydraulic brake caliper 10h having an interlocking multi-piston block configuration with integral side bridge 32h and end bridge 20h is shown. The top bridge 16h is secured, for example, to the side bridges 32h with top bridge bolts 46 and top bridge mounting bolts 42 through top bridge interlocking bushings 44 and secured with bottom nuts 66 and bottom bushings 72. Securely housed within the modular hydraulic brake caliper 10h are brake pads 30h, each disposed adjacent to a piston block (integral with side bridge 32h) that selectively presses the brake pads 30h against the rotor 40. The side bridges 32h utilize abutment plates 18h to secure the brake pads 30h. The integral piston blocks in side bridges 32h are fluidly connected via hydraulic crossover tube 22h, and each has at least one hydraulic tube fitting 24 and hydraulic bleed screw 28.

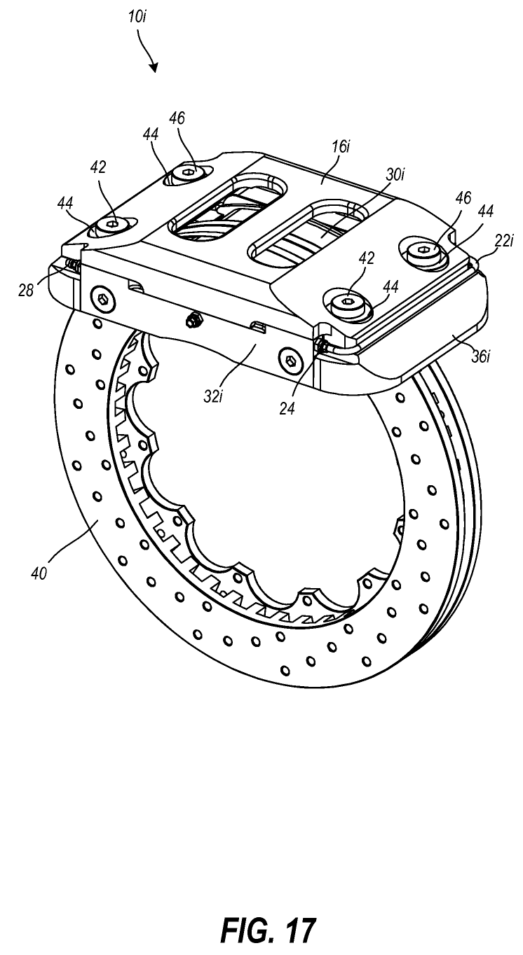

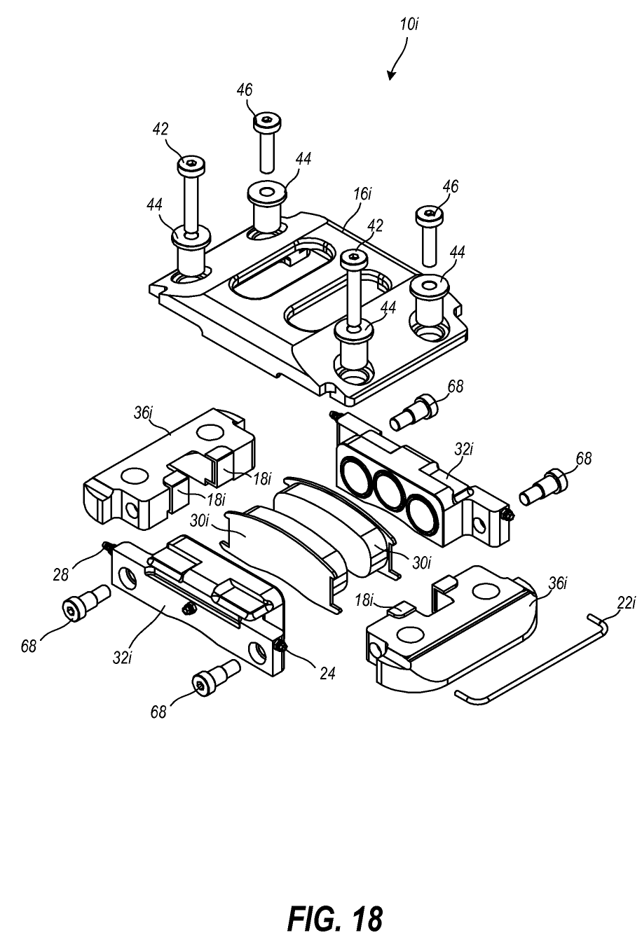

Referring now to FIGS. 17 and 18, a modular hydraulic brake caliper 10i having an interlocking multi-piston block configuration with integral side bridge 32i is shown. The top bridge 16i is secured, for example, to the side bridges 32i with top bridge bolts 46 and top bridge mounting bolts 42 through top bridge interlocking bushings 44. The side bridges 32i are secured to the caliper body 36i with side bridge shoulder bolts 68. Securely housed within the modular hydraulic brake caliper 10i are brake pads 30i, each disposed adjacent to a piston block (integral with side bridge 32i) that selectively presses the brake pads 30i against the rotor 40. The side bridges 32i utilize abutment plates 18i to secure the brake pads 30i. The integral piston blocks in side bridges 32i are fluidly connected via hydraulic crossover tube 22i, and each has at least one hydraulic tube fitting 24 and hydraulic bleed screw 28.

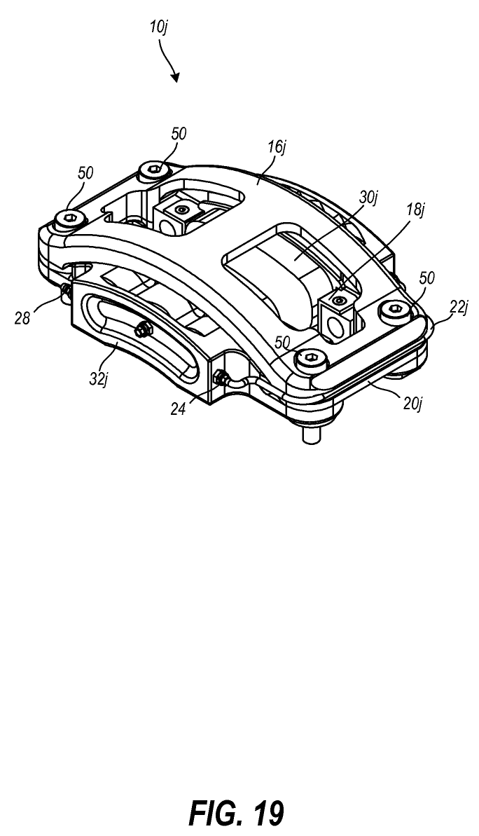

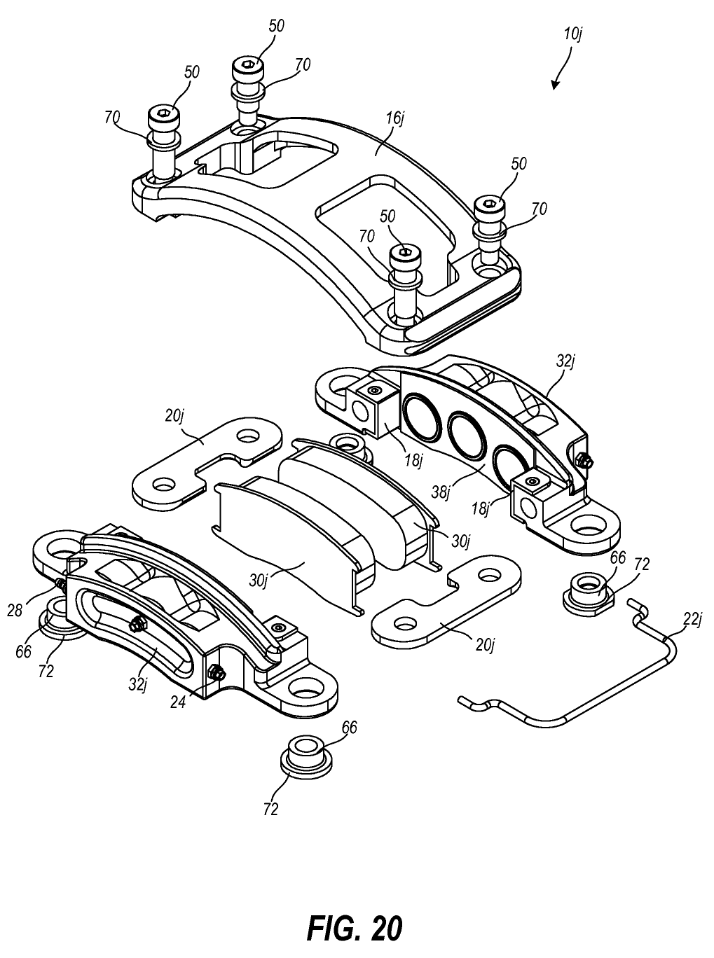

Referring now to FIGS. 19 and 20, a modular hydraulic brake caliper 10j having an interlocking multi-piston block configuration with integral side bridge 32j and end bridge 20j is shown. The top bridge 16j is secured, for example, to the side bridges 32j and end bridges 20j with top bridge shoulder bolts 50 and shoulder bolt washers 70 and connected with bottom nuts 66 and bottom bushings 72. Securely housed within the modular hydraulic brake caliper 10j are brake pads 30j, each disposed adjacent to a piston block (integral with side bridge 32j) that selectively presses the brake pads 30j against a rotor. The side bridges 32j utilize abutment plates 18j to secure the brake pads 30j. The integral piston blocks in side bridges 32j are fluidly connected via hydraulic crossover tube 22j, and each has at least one hydraulic tube fitting 24 and hydraulic bleed screw 28. Heat shields 38j are utilized to reduce radiant heat transfer into the piston block assembly integral in each side bridge 32j.

The various modular hydraulic brake calipers 10 depicted in FIG. 1-20 can be manufactured utilizing varied processes. By way of example, factors such as strength, stiffness, weight, material costs, manufacturing costs, heat resistance, cooling characteristics, and serviceability can be considered. Additionally, application, such as for traditional automobiles or motorcycles or for racing, can be considered. Factors analysis can include results with one or more top bridge 16, one or more side bridge 32, one or more end bridge 20, varied piston block assemblies 26, varied caliper bodies 36, etc.

The following method steps are disclosed: designing a modular hydraulic brake caliper by analyzing the geometric shape, size, and configuration of each component are varied in manufacture in order to yield desired strength and dimensional characteristics; designing a modular hydraulic brake caliper by analyzing the material of manufacture of each of the components in regard to overall weight, strength, and stiffness; designing a modular hydraulic brake caliper by analyzing the material costs; designing a modular hydraulic brake caliper by analyzing the manufacturing costs; designing a modular hydraulic brake caliper by analyzing the heat resistance of the components in order to reduce heat around the piston block and to keep the brake fluid as cool as possible; designing a modular hydraulic brake caliper by analyzing the cooling characteristics in order to allow the greatest amount of air flow around the friction interface of the pad and rotor, rotor cooling vane exhaust, and piston block; and designing a modular hydraulic brake caliper by analyzing the serviceability of the manufacturing components to allow for and prepare for the easy exchange of new, rebuilt, and or different piston configurations with out having to purchase a complete new caliper assembly.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A modular hydraulic disc brake caliper assembly with integral piston block, the caliper assembly comprising:
an at least one top bridge, the top bridge configured to stiffen and strengthen the caliper assembly, to oppose hydraulic forces, to oppose braking forces, and to provide for movement of an air flow through the caliper assembly to cool the caliper assembly;
an at least one side bridge with an integral piston block, the side bridge configured to interconnect with the top bridge, to house an at least one piston that applies force to a brake pad, to deliver pressurized hydraulic brake fluid to an at least one piston bore, to stiffen and strengthen the caliper assembly, to oppose hydraulic forces, and to oppose braking forces; and
an at least one end bridge, the end bridge configured to interconnect with the top bridge and side bridge, to stiffen and strengthen the caliper assembly, to oppose hydraulic forces, and to oppose braking forces.

2. The modular hydraulic disc brake caliper assembly with integral piston block of claim 1, wherein the material of manufacture and the geometric shape, size, and configuration of each of the at least one top bridge, at least one side bridge with an integral piston block, and at least one end bridge comprising the caliper assembly is varied in manufacture in order to optimize weight, strength, and dimensional characteristics.

3. The modular hydraulic disc brake caliper assembly with integral piston block of claim 1, further comprising:
a heat shield, the heat shield disposed upon the integral piston block and configured to reduce radiant heat transfer into the piston block and side bridge;
a coating, the coating applied to one or more of the at least one top bridge, at least one side bridge with an integral piston block, and at least one end bridge comprising the caliper assembly to prevent corrosion, reduce heat transfer, and increase lubricity; and
a means of attachment to interconnect the at least one top bridge, at least one side bridge with an integral piston block, and at least one end bridge comprising the caliper assembly.

4. A modular hydraulic disc brake caliper assembly with integral piston block, the caliper assembly comprising:
an at least one top bridge, the top bridge configured to stiffen and strengthen the caliper assembly, to oppose hydraulic forces, to oppose braking forces, and to provide for movement of an air flow through the caliper assembly to cool the caliper assembly;
an at least one side bridge with an integral piston block, the side bridge configured to interconnect with the top bridge, to house an at least one piston that applies force to a brake pad, to deliver pressurized hydraulic brake fluid to an at least one piston bore, to stiffen and strengthen the caliper assembly, to oppose hydraulic forces, and to oppose braking forces; and
an at least one caliper body, the caliper body configured to interconnect with the top bridge and the side bridge, to stiffen and strengthen the caliper assembly, to oppose hydraulic forces, and to oppose braking forces.

5. The modular hydraulic disc brake caliper assembly with integral piston block of claim 4, wherein the material of manufacture and the geometric shape, size, and configuration of each of the at least one top bridge, at least one side bridge with an integral piston block, and at least one caliper body comprising the caliper assembly is varied in manufacture in order to optimize weight, strength, and dimensional characteristics.

6. The modular hydraulic disc brake caliper assembly with integral piston block of claim 4, further comprising:
a heat shield, the heat shield disposed upon the integral piston block and configured to reduce radiant heat transfer into the integral piston block and caliper body;
a coating, the coating applied to one or more of the at least one top bridge, at least one side bridge with an integral piston block, and at least one caliper body comprising the caliper assembly to prevent corrosion, reduce heat transfer, and increase lubricity; and
a means of attachment to interconnect the at least one top bridge, at least one side bridge with an integral piston block, and at least one caliper body comprising the caliper assembly.

7. A modular hydraulic disc brake caliper assembly with integral piston block, the caliper assembly comprising:
an at least one top bridge, the top bridge configured to stiffen and strengthen the caliper assembly, to oppose hydraulic forces, to oppose braking forces, and to provide for movement of an air flow through the caliper assembly to cool the caliper assembly; and
an at least one side bridge with an integral piston block, the side bridge configured to interconnect with the top bridge, to house an at least one piston that applies force to a brake pad, to deliver pressurized hydraulic brake fluid to an at least one piston bore, to stiffen and strengthen the caliper assembly, to oppose hydraulic forces, and to oppose braking forces.

8. The modular hydraulic disc brake caliper assembly with integral piston block of claim 7, wherein the material of manufacture and the geometric shape, size, and configuration of each of the at least one top bridge and at least one side bridge with an integral piston block comprising the caliper assembly is varied in manufacture in order to optimize weight, strength, and dimensional characteristics.

9. The modular hydraulic disc brake caliper assembly with integral piston block of claim 7, further comprising:
a heat shield, the heat shield disposed upon the integral piston block and configured to reduce radiant heat transfer into the integral piston block and side bridge;
a coating, the coating applied to one or more of the at least one top bridge and at least one side bridge with an integral piston block comprising the caliper assembly to prevent corrosion, reduce heat transfer, and increase lubricity; and
a means of attachment to interconnect the at least one top bridge and at least one side bridge with an integral piston block comprising the caliper assembly.

10. A modular hydraulic disc brake caliper assembly with integral piston block, the caliper assembly comprising:
an at least one top bridge, the top bridge configured to stiffen and strengthen the caliper assembly, to oppose hydraulic forces, to oppose braking forces, and to provide for movement of an air flow through the caliper assembly to cool the caliper assembly; and
an at least one caliper body with an integral piston block, the caliper body configured to interconnect with the top bridge, to house an at least one piston that applies force to a brake pad, to deliver pressurized hydraulic brake fluid to an at least one piston bore, to stiffen and strengthen the caliper assembly, to oppose hydraulic forces, and to oppose braking forces.

11. The modular hydraulic disc brake caliper assembly with integral piston block of claim 10, wherein the material of manufacture and the geometric shape, size, and configuration of each of the at least one top bridge and at least one caliper body with an integral piston block comprising the caliper assembly is varied in manufacture in order to optimize weight, strength, and dimensional characteristics.

12. The modular hydraulic disc brake caliper assembly with integral piston block of claim 10, further comprising:
a heat shield, the heat shield disposed upon the integral piston block and configured to reduce radiant heat transfer into the integral piston block and caliper body;
a coating, the coating applied to one or more of the at least one top bridge and at least one caliper body with an integral piston block comprising the caliper assembly to prevent corrosion, reduce heat transfer, and increase lubricity; and
a means of attachment to interconnect the at least one top bridge and at least one caliper body with an integral piston block comprising the caliper assembly.

13. A modular hydraulic disc brake caliper assembly configured without the use of an integral piston block, the caliper assembly comprising:
an at least one top bridge, the top bridge configured to stiffen and strengthen the caliper assembly, to oppose hydraulic forces, to oppose braking forces, and to provide for movement of an air flow through the caliper assembly to cool the caliper assembly;
an at least one side bridge, the side bridge configured to interconnect with the top bridge, to stiffen and strengthen the caliper assembly, to oppose hydraulic forces, and to oppose braking forces;
an at least one end bridge, the end bridge configured to interconnect with the top bridge and side bridge, to stiffen and strengthen the caliper assembly, to oppose hydraulic forces, and to oppose braking forces; and
an at least one piston block, the piston block configured to house an at least one piston that applies force to a brake pad, to deliver pressurized hydraulic brake fluid to an at least one piston bore.

14. The modular hydraulic disc brake caliper assembly configured without the use of an integral piston block of claim 13, wherein the material of manufacture and the geometric shape, size, and configuration of each of the at least one top bridge, at least one side bridge, at least one end bridge, and at least one piston block comprising the caliper assembly is varied in manufacture in order to optimize weight, strength, and dimensional characteristics.

15. The modular hydraulic disc brake caliper assembly configured without the use of an integral piston block of claim 13, further comprising:
a heat shield, the heat shield disposed upon the piston block and configured to reduce radiant heat transfer into the piston block and side bridge.
a coating, the coating applied to one or more of the at least one top bridge, at least one side bridge, at least one end bridge, and at least one piston block comprising the caliper assembly to prevent corrosion, reduce heat transfer, and increase lubricity; and
a means of attachment to interconnect the at least one top bridge, at least one side bridge, at least one end bridge, and at least one piston block comprising the caliper assembly.

16. A modular hydraulic disc brake caliper assembly configured without the use of an integral piston block, the caliper assembly comprising:
an at least one top bridge, the top bridge configured to stiffen and strengthen the caliper assembly, to oppose hydraulic forces, to oppose braking forces, and to provide for movement of an air flow through the caliper assembly to cool the caliper assembly;
an at least one side bridge, the side bridge configured to interconnect with the top bridge, to stiffen and strengthen the caliper assembly, to oppose hydraulic forces, and to oppose braking forces;
an at least one caliper body, the caliper body configured to interconnect with the top bridge and the side bridge, to stiffen and strengthen the caliper assembly, to oppose hydraulic forces, and to oppose braking forces; and
an at least one piston block, the piston block configured to house an at least one piston that applies force to a brake pad, to deliver pressurized hydraulic brake fluid to an at least one piston bore.

17. The modular hydraulic disc brake caliper assembly configured without the use of an integral piston block of claim 16, wherein the material of manufacture and the geometric shape, size, and configuration of each of the at least one top bridge, at least one side bridge, at least one caliper body, and at least one piston block comprising the caliper assembly is varied in manufacture in order to optimize weight, strength, and dimensional characteristics.

18. The modular hydraulic disc brake caliper assembly configured without the use of an integral piston block of claim 16, further comprising:
a heat shield, the heat shield disposed upon the piston block and configured to reduce radiant heat transfer into the piston block, caliper body, and side bridge;
a coating, the coating applied to one or more of the at least one top bridge, at least one side bridge, at least one caliper body, and at least one piston block comprising the caliper assembly to prevent corrosion, reduce heat transfer, and increase lubricity; and
a means of attachment to interconnect the at least one top bridge, at least one side bridge, at least one caliper body, and at least one piston block comprising the caliper assembly.

19. A modular hydraulic disc brake caliper assembly configured without the use of an integral piston block, the caliper assembly comprising:
an at least one top bridge, the top bridge configured to stiffen and strengthen the caliper assembly, to oppose hydraulic forces, to oppose braking forces, and to provide for movement of an air flow through the caliper assembly to cool the caliper assembly;
an at least one caliper body, the caliper body configured to interconnect with the top bridge, to stiffen and strengthen the caliper assembly, to oppose hydraulic forces, and to oppose braking forces; and
an at least one piston block, the piston block configured to house an at least one piston that applies force to a brake pad, to deliver pressurized hydraulic brake fluid to an at least one piston bore.

20. The modular hydraulic disc brake caliper assembly configured without the use of an integral piston block of claim 19, wherein the material of manufacture and the geometric shape, size, and configuration of each of the at least one top bridge, at least one caliper body, and at least one piston block comprising the caliper assembly is varied in manufacture in order to optimize weight, strength, and dimensional characteristics.

21. The modular hydraulic disc brake caliper assembly configured without the use of an integral piston block of claim 19, further comprising:
a heat shield, the heat shield disposed upon the piston block and configured to reduce radiant heat transfer into the piston block and caliper body;
a coating, the coating applied to one or more of the at least one top bridge, at least one caliper body, and at least one piston block comprising the caliper assembly to prevent corrosion, reduce heat transfer, and increase lubricity; and
a means of attachment to interconnect the at least one top bridge, at least one caliper body, and at least one piston block comprising the caliper assembly.

22. A modular hydraulic disc brake caliper assembly configured without the use of an integral piston block, the caliper assembly comprising:
an at least one top bridge, the top bridge configured to stiffen and strengthen the caliper assembly, to oppose hydraulic forces, to oppose braking forces, and to provide for movement of an air flow through the caliper assembly to cool the caliper assembly;
an at least one side bridge, the side bridge configured to interconnect with the top bridge, to stiffen and strengthen the caliper assembly, to oppose hydraulic forces, and to oppose braking forces; and
an at least one piston block, the piston block configured to house an at least one piston that applies force to a brake pad, to deliver pressurized hydraulic brake fluid to an at least one piston bore.

23. The modular hydraulic disc brake caliper assembly configured without the use of an integral piston block of claim 22, wherein the material of manufacture and the geometric shape, size, and configuration of each of the at least one top bridge, at least one side bridge, and at least one piston block comprising the caliper assembly is varied in manufacture in order to optimize weight, strength, and dimensional characteristics.

24. The modular hydraulic disc brake caliper assembly configured without the use of an integral piston block of claim 22, further comprising:
a heat shield, the heat shield disposed upon the piston block and configured to reduce radiant heat transfer into the piston block and side bridge;
a coating, the coating applied to one or more of the at least one top bridge, at least one side bridge, and at least one piston block comprising the caliper assembly to prevent corrosion, reduce heat transfer, and increase lubricity; and
a means of attachment to interconnect the at least one top bridge, at least one side bridge, and at least one piston block comprising the caliper assembly.
